(19) United States
(12) Patent Application Publication
(10) Pub. No.: US 2026/0355029 A1
(43) Pub. Date: Nov. 12, 2026

(54) TWO-LAYER MOBILITY SCOOTER

(71) Applicant: TUNG KENG ENTERPRISE CO., LTD., TAICHUNG (TW)

(72) Inventor: CHIU-HSIANG LO, TAICHUNG (TW)

(21) Appl. No.: 19/204,611

(22) Filed: May 12, 2025

(51) Int. Cl. A61G 5/04

(52) U.S. Cl. CPC A61G 5/043

(57) ABSTRACT

A two-layer mobility scooter includes a chair assembly on a chassis assembly. The chassis assembly includes two drive wheels, two rear wheels, and two longitudinal bars between the drive wheels and the rear wheels. The chair assembly includes two front wheels at a front portion and two locking units at a rear portion. The locking units are detachably connected to the longitudinal bars to keep the chair assembly on the chassis assembly. The drive wheels are located between the rear wheels and the front wheels.

### BACKGROUND OF INVENTION

### 1. Field of Invention

The present invention relates to a mobility scooter and, more particularly, to a two-layer mobility scooter.

### 2. Related Prior Art

A conventional mobility scooter includes an integral frame, two front wheels attached to the frame, two rear wheels attached to the frame, an electric motor for rotating at least one of the wheels, and several batteries for energizing an electric motor.

The frame cannot be disassembled so that the electric motor and the batteries are always attached to the frame. The entire mobility scooter is heavy and bulky. Hence, it is difficult and often requires two persons to load the entire mobility on another vehicle for driving the entire mobility scooter to a workshop or a storage.

Taiwanese Utility Model Patent No. 415398 discloses a mobility scooter including two subframes (10, 20). The first subframe (10) bears a front wheel (D) and batteries (C). The second subframe (20) bears a driving unit (21) that includes an electric motor. A chair (40) is connected to the first and second subframes. Thus, the mobility scooter includes three portions that is attachable to and detachable from one another. Each portion of the mobility scooter is of course lighter than the entire mobility scooter. It is easy to load one portion of the mobility scooter on another vehicle at a time. A single person can easily handle such a job.

Disclosed is a mechanism expected to ensure that the first and second subframes are connected to each other precisely before use. The first subframe includes two transverse beams (12) extending parallel to a connective beam (13). A vertical tube (14) extends upwards from a portion of the first subframe between the transverse beams and the connective beam.

The second subframe includes a crossbar (221), longitudinal bar (24), a column (23) secured to the crossbar at an upper end and secured to the longitudinal bar at a lower end, and a seat tube (25) secured to a front end of the longitudinal bar, leaving a gap (X) between the seat tube and the column. The second subframe further includes two engaging portions (22) on two opposite sides of the crossbar. A first screw (232) is inserted in a nut (232) secured to the column.

A seat post (30) includes a flange (321) that divides the seat post into a long section (31) and a short section (32). The short section of the seat post is secured to the chair. The long section of the seat post extends downward from the chair.

In assembly, the crossbar of the first subframe supports the engaging portions of the second subframe so that the first subframe bears the second subframe. Two ends of the connective beam are inserted in the engaging portions of the second subframe. The engaging portions of the second subframe are supposed to keep the connective beam in tight contact with the crossbar. The first screw is operable to adjust how far it extends from the nut, thereby adjusting the gap between the vertical tube and the column. The first subframe is pivotally connected to the second subframe, thereby providing a front-and-rear configuration. The long section of the seat post is inserted in the seat tube and the vertical tube. A second screw (252) is used to keep the long section of the seat post in position relative to the seat tube, thereby keeping the chair at a desired height.

Problems have been encountered during the use of this mobility scooter. Firstly, it takes a long period of time to connect the first and second subframes to each other because the first and second subframes together include numerous elements. Secondly, the structure of the frame is not rigid for solely depending on the second screw to connect the first and second subframes and the seat post to one another while the use of the first screw is inadequate to keep the first and second subframes in position relative to each other. The reference numbers in brackets for the elements are given as used in the above-captioned Taiwanese Utility Model Patent and should not be confused with the following reference numbers for the elements of the present invention.

The present invention is therefore intended to obviate or at least alleviate the problems encountered in the prior art.

### SUMMARY OF INVENTION

It is an objective of the present invention to provide an easy-to-transport and sturdy-to-use two-layer mobility scooter.

To achieve the foregoing objectives, the two-layer mobility scooter includes a chair assembly on a chassis assembly. The chassis assembly includes two drive wheels, two rear wheels, and two longitudinal bars between the drive wheels and the rear wheels. The chair assembly includes two front wheels at a front portion and two locking units at a rear portion. The locking units are detachably connected to the longitudinal bars to keep the chair assembly on the chassis assembly. The drive wheels are located between the rear wheels and the front wheels.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a mobility scooter according to the preferred embodiment of the present invention;

FIG. 2 is a perspective view of the mobility scooter shown in FIG. 1; and

FIG. 3 is a side view of the mobility scooter shown in FIG. 2.

### DETAILED DESCRIPTION OF PREFERRED EMBODIMENT

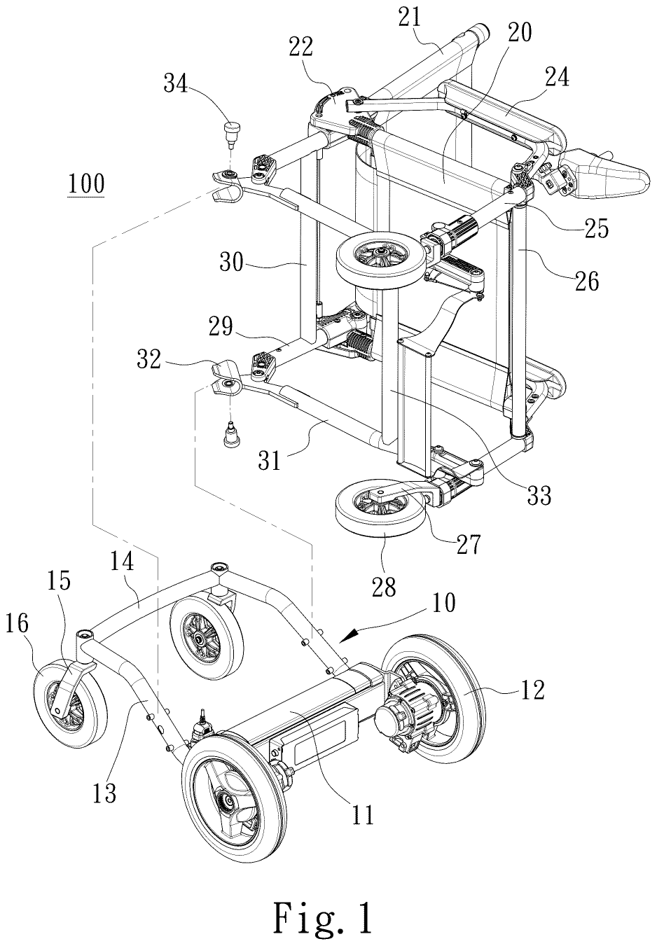

Referring to FIG. 1, a mobility scooter 100 includes a lower layer and an upper layer according to the preferred embodiment of the present invention. The lower layer is a chassis assembly 10 and the upper layer is a chair assembly 20.

Chassis assembly 10 includes a transmission 11, two drive wheels 12, two longitudinal bars 13, a crossbar 14 and two rear wheels 16. Transmission 11 is located between and secured to longitudinal bars 13, which are separated from each other by a proper gap, Similarly, crossbar 14 is located between and secured to longitudinal bars 13. Crossbar 14 is located opposite to transmission 11. Transmission 11, longitudinal bars 13 and crossbar 14 together form a frame. Two electric motors (not shown) are supported on this frame and operatively connected to transmission 11. Transmission 11 is located between and operatively connected to drive wheels 12. Thus, drive wheels 12 are driven by the electric motors through transmission 11. A fork 15 is pivotally connected to the connection of each longitudinal bar 13 to crossbar 14. Each rear wheel 16 is rotationally connected to a corresponding fork 15.

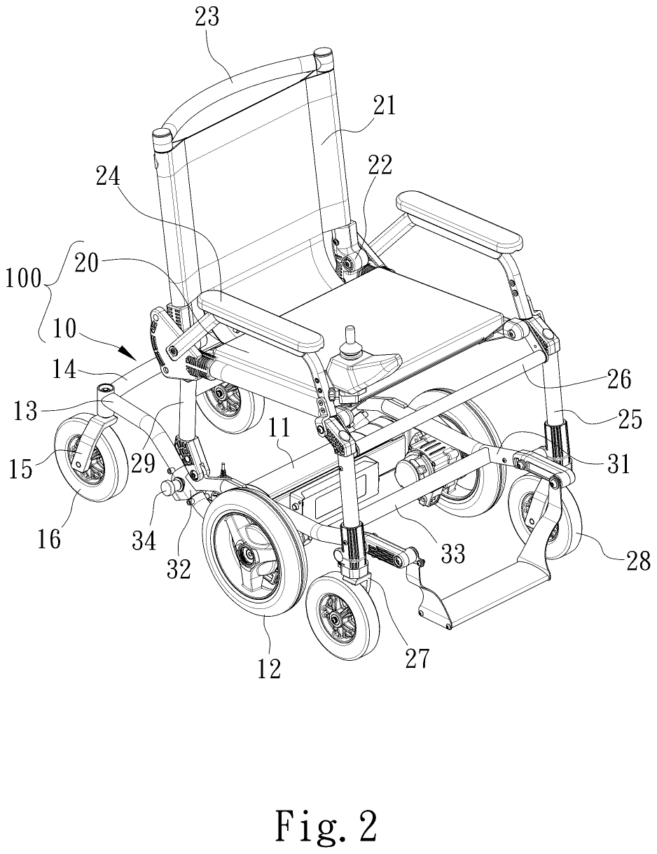

Chair assembly 20 includes a backrest 21, two adjustment units 22, a handle 23 (FIG. 2), two armrests 24, two front posts 25, two front wheels 28, two rear posts 29, two longitudinal rods 31, two locking units 32 and several linking members 26, 30 and 33. Backrest 21 is pivotally connected to a seat (not numbered) via adjustment units 22. Adjustment units 22 are operable to change the angle of backrest 21 relative to the seat. In a most forward position, backrest 21 is almost in contact with the seat. In a most backward position, backrest 21 is located behind the seat. Handle 23 is secured to an upper portion of backrest 21. The seat is located between armrests 24. A controller (not shown) is attached to one armrest 24. The controller is operable to control transmission 11. A wheel-supporting element 27 is pivotally connected to a lower end of each front post 25. Each wheel-supporting element 27 supports a corresponding front wheel 28. A lower portion of chair assembly 20 is located between front wheels 28. Rear posts 29 extend downwards from the seat. Each longitudinal rod 31 is located between and connected to a corresponding rear post 29 and a corresponding front post 25. A tread (not numbered) is connected to longitudinal rods 31 so that the tread extends between front wheels 28. Each locking unit 32 is located at the connection of a corresponding rear post 29 to a corresponding longitudinal rod 31. Thus, a rear portion of chair assembly 20 is located between locking units 32. Linking member 26 is located between front posts 25. Linking member 30 is located between and secured to rear posts 29. Linking member 33 is located between and secured to longitudinal rods 31. Thus, linking members 26, 30 and 33 reinforce the structure of chair assembly 20.

Referring to FIG. 2, chair assembly 20 is located on the chassis assembly 10, thereby providing a two-layer configuration for mobility scooter 100. At least one battery (not shown) is located on the chassis assembly 10. The battery does not protrude from mobility scooter 100, thereby minimizing the size of mobility scooter 100 and providing an adequate strength for mobility scooter 100.

Each locking unit 32 is a U-shaped element for mounting a corresponding longitudinal bar 13. A fastener 34 is inserted in a corresponding locking unit 32 and a longitudinal bar 13 to render each locking unit 32 pivotable relative to a corresponding longitudinal bar 13 about a corresponding fastener 34.

Fasteners 34 are operable to allow chair assembly 20 to be detached from chassis assembly 10. Thus, the upper and lower layers of mobility scooter 100 are detached from each other.

As discussed above, the upper and lower layers of mobility scooter 100 is quickly attached to or detached from each other. The operation is easy. The battery is detachable from chassis assembly 10. Thus, it is easy to turn mobility scooter 100 into several pieces and move one such piece at a time. The movement can be done by a single person.

Locking units 32 can use other elements instead of fasteners 34 to keep chair assembly 20 on chassis assembly 10.

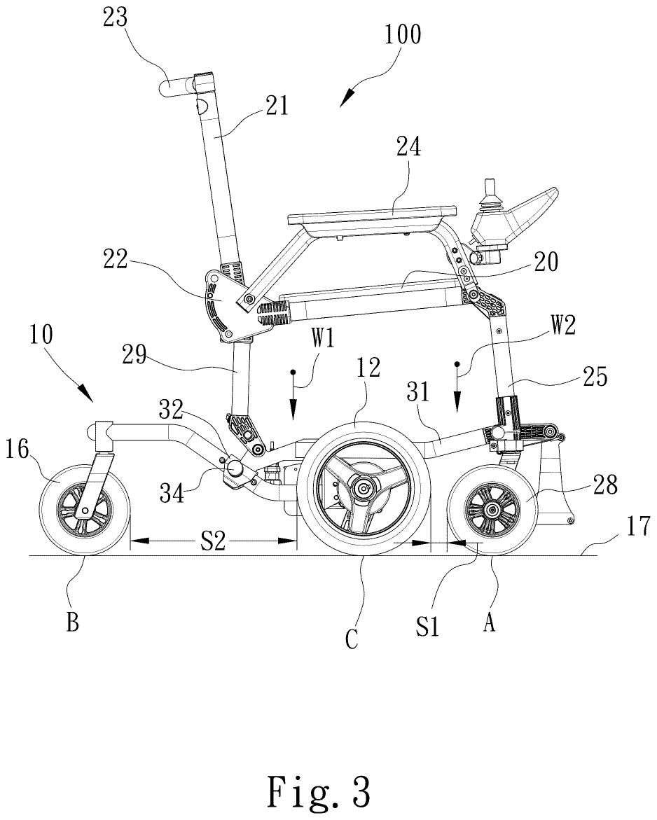

Referring to FIG. 3, mobility scooter 100 is located on a floor 17. A rear wheel 16 is in contact with floor 17 at a point B relatively far from a front wheel 28. Drive wheels 12 are away from rear wheels 16 by a distance S2. A drive wheel 12 is in contact with floor 17 at a point C between a rear wheel 16 and a corresponding front wheel 28. Front wheels 28 are away from drive wheels 12 by a distance S1 shorter than distance S2. A front wheel 28 is in contact with floor 17 at a point A. Point C is located between points A and B. Points A, B and C are in a same plane as floor 17 is planar. Points A, B and C are not in a same plane as floor 17 is not planar.

To sit on mobility scooter 100, a user can hold armrests 24 to draw his-or herself close to chair assembly 20. The user turns to a center of weight W1 to a center of weight W2.

Center of weight W1 is located between points A and B. That is, center of weight W1 is in a large rectangle determined by two points A and two points B. Hence, it is difficult for the user and mobility scooter 100 to turn over on floor 17.

Center of weight W2 is located between points A and C. front wheels 28 and drive wheels 12 form a primary area. Drive wheels 12 and rear wheels 16 form a secondary area. The primary and secondary areas keep the user steady relative to mobility scooter 100.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A two-layer mobility scooter comprising:
a chassis assembly comprising two drive wheels, two rear wheels, and two longitudinal bars between the drive wheels and the rear wheels; and
a chair assembly comprising two front wheels at a front portion and two locking units at a rear portion;
wherein the locking units are detachably connected to the longitudinal bars to keep the chair assembly on the chassis assembly;
wherein the drive wheels are located between the rear wheels and the front wheels.

2. The two-layer mobility scooter according to claim 1, wherein a distance of the front wheels from the drive wheels is shorter than a distance of the drive wheels from the rear wheels.
